(19) United States
(12) Patent Application Publication
(10) Pub. No.: US 2009/0255555 A1
(43) Pub. Date: Oct. 15, 2009

(54) Advanced cleaning process using integrated momentum transfer and controlled cavitation

(75) Inventors: Roman Gouk, San Jose, CA (US); Chung-Huan Jeon, San Jose, CA (US); Zhiyong Li, San Jose, CA (US); Madhava Rao Yalamanchili, Morgan Hill, CA (US); James S. Papanu, San Rafael, CA (US)

Correspondence Address: APPLIED MATERIALS/BSTZ;BLAKELY SOKOLOFF TAYLOR & ZAFMAN LLP, 1279 OAKMEAD PARKWAY, SUNNYVALE, CA, 94085-4040, US

(73) Assignee: BLAKELY, SOKOLOFF, TAYLOR & ZAFMAN, Los Angeles, CA (US)

(21) Appl. No.: 12/082,750

(22) Filed: Apr. 14, 2008

(51) Int. Cl. B08B 3/12; B08B 13/00

(52) U.S. Cl. 134/1; 134/95.3

(57) ABSTRACT

A method and apparatus for cleaning a workpiece are disclosed. A gas and cleaning solution are supplied to an atomizing nozzle which atomizes the cleaning solution and sprays the top surface of a workpiece with an atomized spray. A liquid having a controlled gas content is flowed to the top surface of the workpiece from a rinse nozzle. Megasonic energy is applied from the backside of the workpiece.

### BACKGROUND OF THE INVENTION

1. Field of the Invention

Embodiments of the present invention relate to the field of semiconductor processing and manufacturing. More particularly embodiments of this invention relate to the area of cleaning a workpiece.

As semiconductor devices become increasingly more complex and the technology nodes continue to shrink below 90 nm, cleaning of workpieces is also becoming more critical. For example, photomask manufacturing is becoming more critical and requires new approaches and techniques. As shown in FIG. 1A conventional photomask manufacturing typically begins with a transparent substrate 102, such as quartz. A phase shift layer 104 such as MoSiₓ is disposed over the quartz substrate 102. A Cr layer 106 is disposed over phase shift layer 104, and an antireflective (ARC) coating 108, such as CrOₓ, is disposed over the Cr layer 106. Finally, a photoresist layer 110 is formed over ARC coating 108.

As shown in FIG. 1B, photoresist layer 110 is exposed with an electron (or laser) beam and developed to form a predetermined circuitry pattern in the photoresist layer 110. Thereafter, as shown in FIG. 1C, selective etch chemistries are utilized to selectively etch the ARC layer 108, Cr layer 106, and the phase shift layer 104 while using the photoresist pattern 110 as an etching mask (though Cr layer 106 can also be used as hard mask for phase shift layer 104 etch). The remaining first electron beam photoresist layer 110 is then stripped in FIG. 1D.

Then a second photoresist layer 112 is formed on the patterned ARC layer 108 and quartz substrate 102, as shown in FIG. 1E. Photoresist layer 112 is exposed with an electron (or laser) beam and developed to form a second predetermined circuitry pattern as shown in FIG. 1F. Thereafter, the exposed portions of ARC layer 108 and Cr layer 106 are removed by using the second photoresist pattern 112 as the etching mask, as shown in FIG. 1G. Finally, the remaining photoresist 112 is stripped in FIG. 1H.

After each etching or stripping operation the photomask must generally be cleaned to remove any surface particles. Conventional photomask cleaning technologies use fluid sprays and megasonic finger jet nozzles to physically remove surface particles. FIG. 2 is an illustration of a conventional cleaning technology. As shown in FIG. 2 nozzle 202 emits a spray 208 as the nozzle 202 is scanned over the top surface of a rotating photomask. In the case of a fluid spray nozzle 202, a liquid such as DI water or cleaning liquid is emitted as spray 208 at a high pressure to physically remove particles in a localized region. In the case of a megasonic finger jet nozzle, a megasonic transducer 206 is included to apply megasonic energy to the DI water or cleaning liquid entering the nozzle 202. The finger jet nozzle 202 emits a high pressure spray 208 containing megasonic energy as the finger jet nozzle 202 is scanned over the top surface of the photomask 204. The megasonic energy in the spray 208 additionally causes cavitation on the top surface of the photomask 204.

However, cleaning with both fluid sprays and megasonic finger jet nozzles can be problematic because the physical particle removal forces in the spray 208 (associated with high pressure and/or megasonic energy) are concentrated in a small area that is scanned over the entire photomask surface. Additionally, small particles redistribute or redeposit elsewhere on the photomask due to a varying hydrodynamic boundary layer over the photomask surface caused by the spray 208. Accordingly, conventional cleaning techniques are constrained by only being able to achieve either a high particle removal efficiency (PRE) at the expense of high pattern damage, or low PRE with low pattern damage. Thus a more efficient cleaning process is needed.

### SUMMARY

Embodiments of the present invention disclose a method and apparatus for cleaning a workpiece. A gas and cleaning solution are supplied to an atomizing nozzle which atomizes the cleaning solution and sprays the top surface of a workpiece with an atomized spray. A liquid having a controlled gas content is flowed to the top surface of the workpiece from a rinse nozzle. Megasonic energy is applied from the backside of the workpiece. The megasonic energy may be applied simultaneously with or sequential to applying the atomized spray. The improved cleaning process incorporates an atomized spray, distributed megasonic power, and controlled cavitation to achieve a good PRE with low pattern damage.

### BRIEF DESCRIPTION OF THE DRAWINGS

FIGS. 1A-1H are side view illustrations of a conventional photomask manufacturing method.

FIG. 2 is a side view illustration of a conventional photomask cleaning apparatus.

FIGS. 3A-3B are side view illustrations of a photomask cleaning apparatus according to embodiments of the invention.

FIG. 4 is an illustration of one embodiment of a sweep pattern for cleaning a photomask.

FIG. 5 is a schematic diagram illustration of one embodiment of an atomizing nozzle.

FIG. 6 is cross-sectional side view illustration of an atomizing nozzle.

FIG. 7 is a flow diagram for a method of cleaning a photomask according to one embodiment of the invention.

FIG. 8 is a flow diagram for a method of cleaning a photomask according to one embodiment of the invention.

FIG. 9 is a flow diagram for a method of cleaning a photomask according to one embodiment of the invention.

### DETAILED DESCRIPTION

Embodiments of the present invention disclose an apparatus and method for cleaning a workpiece.

Various embodiments described herein are described with reference to figures. However, certain embodiments may be practiced without one or more of these specific details, or in combination with other known methods and configurations. In the following description, numerous specific details are set forth, such as specific configurations, compositions, and processes, etc., in order to provide a thorough understanding of the present invention. In other instances, well-known semiconductor processes and manufacturing techniques have not been described in particular detail in order to not unnecessarily obscure the present invention. Reference throughout this specification to “one embodiment” or “an embodiment” means that a particular feature, configuration, composition, or characteristic described in connection with the embodiment is included in at least one embodiment of the invention. Thus, the appearances of the phrase “in one embodiment” or “an embodiment” in various places throughout this specification are not necessarily referring to the same embodiment of the invention. Furthermore, the particular features, configurations, compositions, or characteristics may be combined in any suitable manner in one or more embodiments.

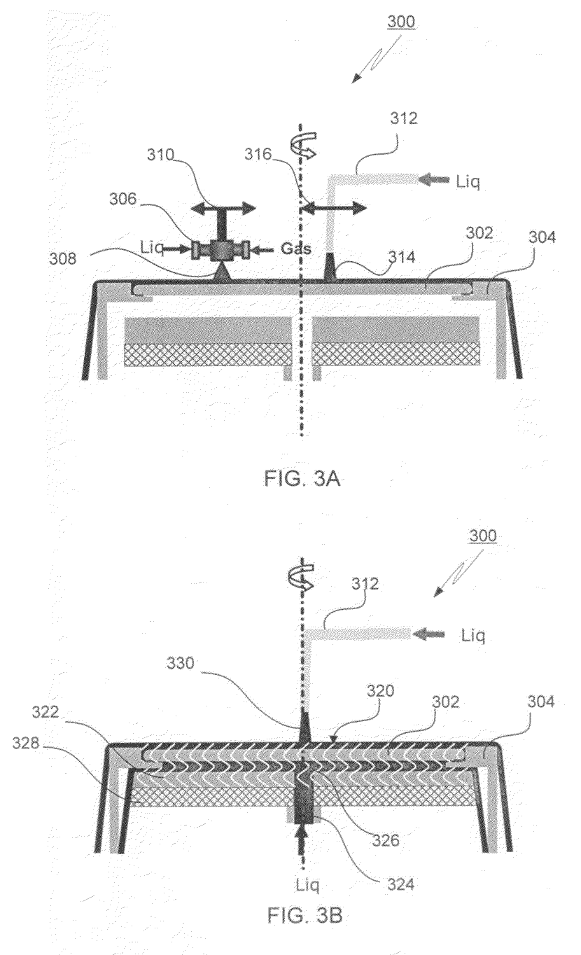

FIG. 3 to FIG. 9 are illustrations of an apparatus and method for cleaning a workpiece, such as a photomask. In other applications the workpiece can be a semiconductor workpiece, e.g. a wafer. In one embodiment, a method for cleaning a photomask comprises spraying droplets of an atomized cleaning solution onto the top surface of a photomask and applying megasonic energy from the backside of the photomask. In an embodiment, an atomizing nozzle dispensing an atomized spray, and rinse nozzle dispensing a rinse solution are simultaneously swept across the top surface of the photomask. The atomized spray dislodges particles from the top surface of the photomask and the rinse solution assists in carrying away the dislodged particles from the surface of the photomask as the photomask is rotated. Localized damage to the photomask that can be attributed to high pressure sprays or finger jet nozzles is avoided.

In an embodiment, the atomized cleaning solution comprises a first alkaline standard clean (SC1) chemistry (commonly containing hydrogen peroxide and ammonium hydroxide in deionized water). In an embodiment, the atomized cleaning solution comprises an ammonium hydroxide (NH4OH) chemistry referred herein as “AM-Clean.” AM-Clean is a mixture of NH4OH, H2O2, DI H2O, a chelating agent, and a surfactant. In a particular embodiment, the AM-Clean chemistry comprises a mixture of 1:2:80-300 by volume of an aqueous solution of NH4OH with surfactants and chelating agents available under the trade name “AM1” as manufactured by Mitsubishi Chemical, Tokyo, Japan, H2O2, and DI H2O, respectively.

In an embodiment, a liquid having a controlled gas content is flowed to the top surface of the photomask from a rinse nozzle simultaneously with applying the megasonic energy from the backside of the photomask. In one embodiment, the liquid having a controlled gas content comprises degasified DI water. In an embodiment, the liquid having a controlled gas content comprises an alkaline solution such as an AM-Clean chemistry or SC1 chemistry diluted with DI water. In an embodiment, the DI water component may be degasified to contain less than 30 ppb dissolved O2 gas. Furthermore, the degasified DI water may also have additional inert gas such as H2, He, Ar, or N2 added so that the degasified DI water contains 0.3-18 ppm dissolved gas. A low intensity cavitation megasonic cleaning process is accomplished by controlling the gas content in liquid on the top surface of the photomask while applying relatively low powered megasonic energy at a power range of 0.16-0.016 W/cm2. Furthermore, applying megasonic energy from the backside distributes the megasonic power across the photomask. Thus, localized damage to the photomask that can be attributed to megasonic finger jet nozzles is avoided.

Accordingly, the improved photomask cleaning process achieves an increased particle removal efficiency with low pattern damage compared to conventional techniques. Large particles over approximately 80 nm can be effectively removed while applying the atomized spray, and particles under approximately 80 nm can be effectively removed while applying megasonic energy from the backside of the photomask. The improved photomask cleaning process incorporating an atomized spray, distributed megasonic power, and controlled cavitation is particularly useful for cleaning photomasks with patterns of less than 80 nm, where conventional cleaning techniques result in an unacceptable amount of damage to the photomask.

In one embodiment, the atomized cleaning solution and megasonic energy are applied sequentially. The atomizing nozzle and rinse nozzle are simultaneously swept across the topside of the photomask. The spray from the atomizing nozzle is ceased, and the rinse nozzle flows a rinse solution onto the topside of the workpiece. Flow of the rinse solution may then be ceased. Megasonic energy is then applied from the backside of the photomask while flowing a liquid having a controlled gas content to the topside of the photomask. The photomask is then rinsed and dried.

In another embodiment, the atomized cleaning solution and megasonic energy are applied simultaneously. The atomizing nozzle and rinse nozzle are simultaneously swept across the topside of the photomask, while megasonic energy is also simultaneously applied from the backside of the photomask. This operation may then be repeated with rinse operations before and after. The photomask is then dried.

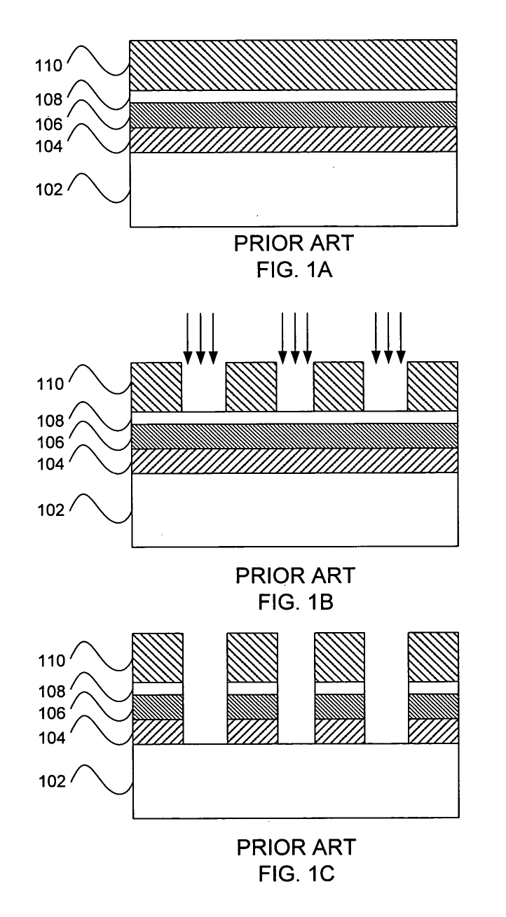

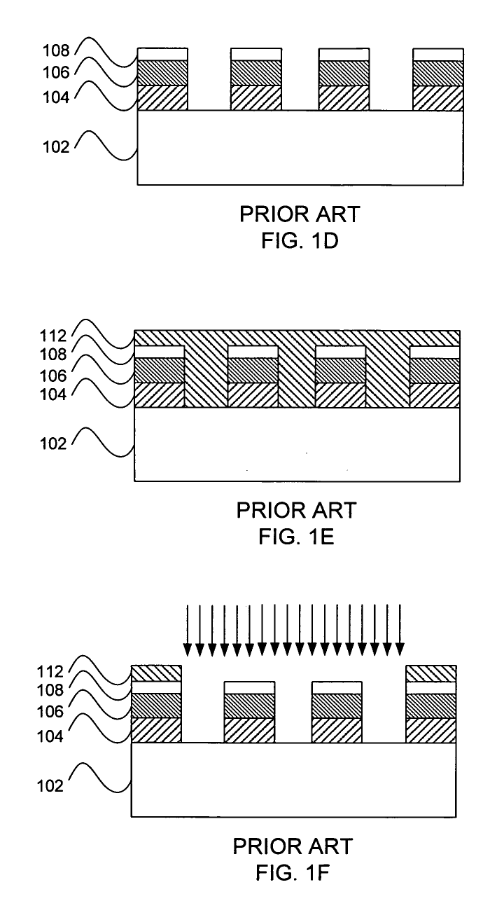

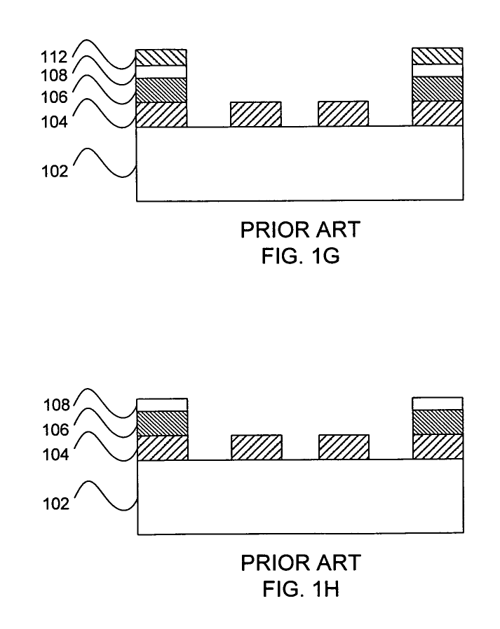

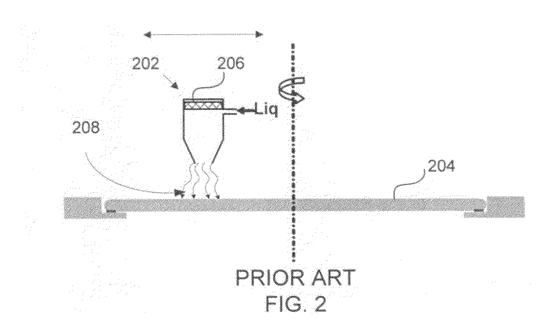

Embodiments the invention described herein are particularly useful for cleaning and removal of surface particles from the top surface of a photomask that are disposed during conventional photomask manufacturing, such as described in FIG. 1. It is to be appreciated, that while embodiments of the invention are described with respect to cleaning of a photomask, that embodiments of the invention could also be practiced with other workpieces such as silicon or GaAs wafers.

FIG. 3A and FIG. 3B are illustrations of an apparatus 300 for cleaning a photomask 302. A photomask support 304 supports the photomask 302. The photomask support 304 is capable of spinning as further described below. An atomizing nozzle 306 is disposed above the photomask 302. The atomizing nozzle 306 sprays atomized cleaning solution droplets in the form of an atomized spray 308 to locally remove particles or contaminants from the photomask 302 without damaging the surface features of the photomask 302. In one embodiment, the cleaning solution comprises of DI water or a diluted alkaline chemistry such, but not limited to, as AM-Clean chemistry or SC1 chemistry. The atomizing nozzle 306 may move along a planar path 310 above the photomask 302 and photomask support 304.

A rinse nozzle 312 may be disposed above the photomask 302 to flow a rinsing solution 314 to the photomask 302. The rinsing solution 314 assists in carrying away the dislodged particles from the surface of the photomask 302 as the photomask support 304 rotates the photomask 302. The rinsing solution 314 comprises, for example, DI water or an alkaline diluted AM-Clean or SC1 chemistry. In an embodiment, the rinsing solution 314 comprises degasified DI water. In one embodiment, degasified DI water is DI water having a dissolved O2 concentration of less than 30 ppb. A specific amount of gas may also be redissolved into the degasified DI water. In an embodiment, approximately 0.3-18 ppm of inert gas as such as H2, He, Ar, or N2, or combination thereof, is dissolved in the degasified DI water having a dissolved O2 concentration of less than 30 ppb. The rinse nozzle 312 may move along a planar path 316 above the photomask 302 and photomask support 304.

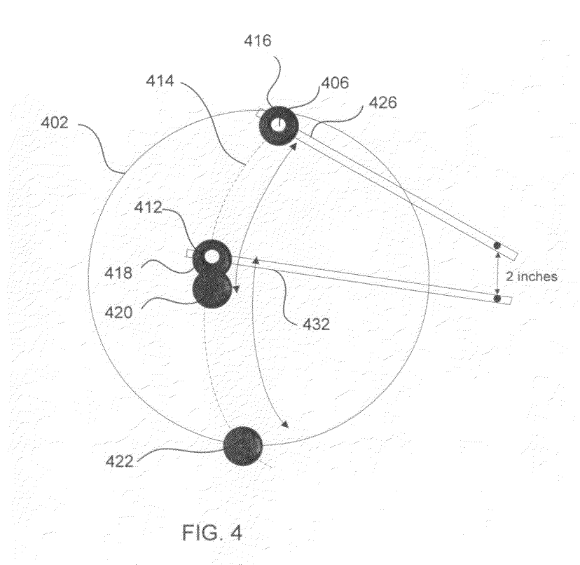

FIG. 4 is an illustration of one embodiment of sweeping the atomizing nozzle 406 and rinse nozzle 412. In the embodiment illustrated in FIG. 4, atomizing nozzle 406 attached with translatable arm 426, and rinse nozzle 412 attached with translatable arm 432 sweep across the photomask 402 and photomask support substantially along the same path 414. The paths may not be entirely the same because the translatable arms 426 and 432 are separated by a distance of, for example 2 inches when the photomask 402 is a 200 mm photomask. In an embodiment, the nozzles 406, 412 simultaneously sweep along path 414. In an embodiment, atomizing nozzle 406 is in position 416 near the edge of photomask 402 while rinse nozzle 412 is in position 418 off-center of the photomask 402. In such an embodiment, the nozzles sweep across the photomask 402 and photomask support substantially along the same path 414, so that atomizing nozzle 406 is in position 420 while rinse nozzle 412 is in position 422. In an embodiment, a full sweep cycle for atomizing nozzle 406 is from position 416 to position 420 and back to position 416. In an embodiment, a full sweep cycle for rinse nozzle 412 is from position 412 to position 422 and back to position 412.

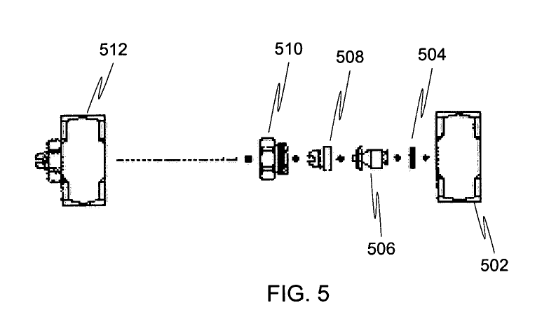

FIG. 5 illustrates one embodiment of an atomizing nozzle. An atomizing nozzle body 502 is coupled to a liquid cap 506 with an O-ring 504. The liquid cap 506 is combined with an air cap 508. A retainer ring 510 couples the air cap 508, the liquid cap 506, and the O-ring 504 with the nozzle body 502 to form the assembled nozzle 512. The liquid cap 506 provides a conduit and passageway for a liquid. The air cap 508 provides a conduit and passageway for a gas, such as nitrogen gas.

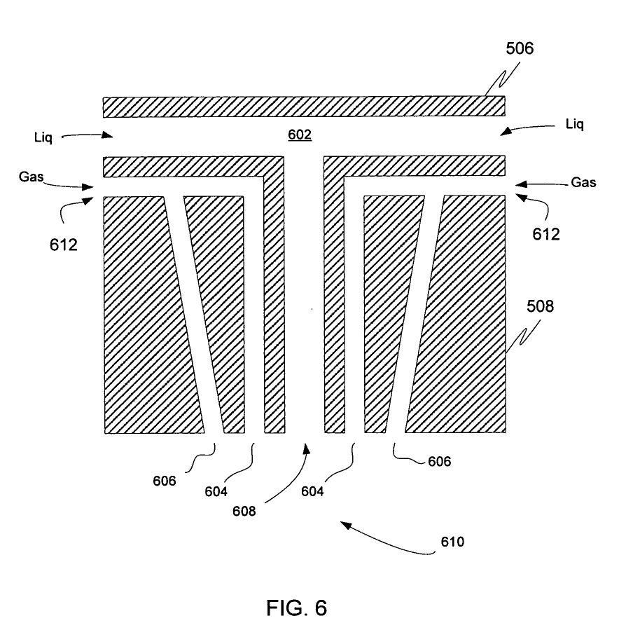

FIG. 6 is a cross-sectional side view illustration of the air cap 508 and the liquid cap 506 of nozzle 512 of FIG. 5. A source of cleaning solution (not shown) provides cleaning solution to the liquid cap 506. A source of gas (not shown) provides gas, such as nitrogen gas, to the gas cap 508.

The liquid cap 506 includes a main channel 602 formed through a center of the liquid cap 506 and includes an aperture 608 in a central region at an end of the nozzle 512. The gas cap 508 includes two channels 604, 606 through which gas may travel. In particular, channel 604 may be adjacent to the main channel 602 of the fluid cap 506. Channel 606 may be formed peripherally adjacent and at an acute angle to channel 604. Gas cap 508 may include a number of channels to further facilitate atomization of the liquid.

In accordance with one embodiment, nitrogen gas is introduced in the nozzle 512 through channel 612. Cleaning solution is introduced into the nozzle 512 through the main channel 602. The nitrogen gas and cleaning solution are initially mixed outside the nozzle 512 at room temperature. Those of ordinary skill in the art will recognize that the nitrogen gas and cleaning solution may be introduced and mixed at other different temperatures.

The nitrogen gas output by channels 604, 606 is initially mixed with the output of the aperture 608 at an external mixing region 610 outside the nozzle 512 to generate atomized droplets of cleaning solution. The external mixing region 610 may be below the nozzle 512 and above the surface of the photomask. One advantage of using the particular nozzle design 512 described in FIG. 6 is that by initially mixing the nitrogen gas and cleaning solution outside the nozzle 512 a wider spray pattern can be accomplished. A second advantage is that by initially mixing the gas and cleaning solution outside of the nozzle 512 less erosion occurs and the nozzle 512 lifetime is extended.

Referring again to FIG. 3A, in accordance with one embodiment the atomizing nozzle 306 may spray at different angles. In an embodiment atomizing nozzle 306 is tilted 10-15 degrees from normal to the photomask 302. Tilting the atomizing nozzle 306 at an acute angle reduces the force directly applied to the fragile features on the top surface of the photomask. However, if angles substantially larger than 10-15 degrees are utilized then too much momentum is lost and particle removal efficiency is reduced.

In an embodiment, the spacing between the atomizing nozzle 306 and photomask 302 may be within a range of about 15-100 mm, while spacing ranges for conventional nozzles in semiconductor cleaning are typically far over 150 mm. The distance between the atomizing nozzle 306 and the photomask 302 is adjusted for an optimized spray such that the spray is able to efficiently remove particles or contamination above approximately 80 nm without causing any feature damage. In an embodiment, the distance is approximately 20-50 mm. In an embodiment, atomizing nozzle 306 and rinse nozzle 312 are the same distance from the photomask 302.

Referring back to FIG. 3B, apparatus 300 is further configured to apply megasonic energy 320 from the backside of the photomask 302. A photomask support 304 supports the photomask 302. The photomask support 304 can be raised and lowered while maintaining the photomask 302 parallel and adjacent to a platter 322. In one embodiment, platter 322 is circular and has a diameter slightly larger than the diameter of photomask 302. The top surface of the platter 322 located beneath the photomask is flat, and the distance separating the platter 322 and photomask 302 is uniform. A through hole 324 in the platter 322 delivers a liquid 326 to the backside of the photomask 302. Liquid 326 can be DI water, or alternatively the same cleaning solution as supplied to atomizing nozzle 306 or the same rinse solution as supplied to rinse nozzle 312. In an embodiment, liquid 326 is supplied at a sufficient flow rate to completely fill the space between platter 322 and photomask 302 when megasonic energy 320 is applied from the backside of the photomask 302. The megasonic energy 320 is transferred to the photomask 302 through liquid coupling.

In one embodiment, platter 322 has a transducer plate 328 attached to the bottom side for providing acoustic energy. In such an embodiment, platter 322 is made of a material that efficiently transmits acoustic energy such as, for example, stainless steel or aluminum. In one embodiment, transducer place 328 covers the entire bottom side of platter 322, and generates sonic waves in the frequency range between 400 kHz and 8 MHz in a direction perpendicular to the bottom surface of photomask 302. In another embodiment, multiple transducers may be placed on the bottom side of platter 322.

Rinse nozzle 312 is positioned above the platter 322 and photomask 302 to provide a liquid having a controlled gas content 330 to the topside of the photomask 302. In one embodiment liquid 330 comprises degasified DI water, and may be flowed to the top surface of the photomask from rinse nozzle 312 simultaneously with applying the megasonic energy 330 from the backside of the photomask 302. The liquid 330 is, for example, DI water or a diluted alkaline chemistry such as AM-Clean chemistry or SC1 chemistry. In an embodiment, the DI water component of the liquid 330 may be degasified to contain less than 30 ppb dissolved O2 gas. In an embodiment the DI water component of the liquid 330 is degasified to contain less than 10 ppb dissolved O2 gas. Furthermore, the degasified DI water component may also have 0.3-18 ppm inert gas, such as H2, He, Ar, or N2, dissolved in order to control cavitation in the rinsing solution 330.

In an embodiment, when transducer plate 328 is turned on, megasonic energy 320 transfers through platter 322, through liquid 326 between the platter 322 and photomask 302, through photomask 302, and into the liquid having a controlled gas content 330 on the top surface of photomask 302. By controlling the gas content in the liquid 330 flowed to the top surface of the photomask 302 while applying megasonic power from the backside of the photomask 302 the amount of cavitation on the top surface of the photomask 302 can be controlled so that the fragile structures on the topside of the photomask 302 are not damaged.

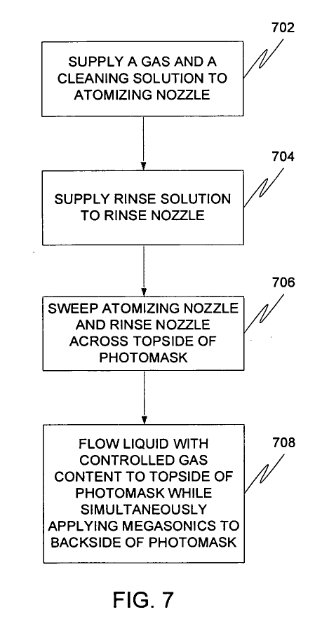

FIG. 7-FIG. 9 will now be discussed with reference to the illustration in FIG. 3A and FIG. 3B.

FIG. 7 is a flow diagram of a method for cleaning a photomask in accordance with one embodiment. At 702 a gas and cleaning solution are supplied to an atomizing nozzle 306. In an embodiment the gas is N2 gas supplied at a flow rate of 70,000-140,000 sccm and the cleaning solution is supplied at approximately 50-70 mL/min. The cleaning solution is, for example, a diluted AM-Clean chemistry or SC1 chemistry. In an embodiment, the cleaning solution has a 1:2:80-300 ratio of (AM1 chemistry or NH4OH):H2O2:DI water. Inclusion of the AM1 chemistry in the cleaning solution is beneficial because the AM1 chemistry includes a surfactant which assists in wetting of the photomask 302. Alternatively a surfactant can by added to the cleaning solution individually. In an embodiment, the DI water in the cleaning solution is degasified and has a dissolved O2 concentration less than 30 ppb. In an embodiment, H2, He, Ar, or N2 gas is added to the degasified DI water at a concentration of 0.3-18 ppm.

At 704 a rinse solution is supplied to a rinse nozzle 312. The rinse solution may be DI water or the same solution as the cleaning solution in 702. In an embodiment, the rinse solution is an AM-Clean chemistry diluted with DI water. Similarly, the DI water component may be degasified, and include an additional gas such as H2, He, Ar, or N2.

At 706 the atomizing nozzle 306 and rinse nozzle 312 are swept across the topside of the photomask 302 while the photomask 302 is spinning. In an embodiment, the photomask 302 spins at 75-100 rpm. The atomized cleaning solution and rinse solution are applied to the photomask at room temperature with a sweep rate of approximately 2 complete sweep cycles per minute. In an embodiment, the atomizing nozzle 306 and rinse nozzle 312 are operated by independent translatable arms with different motors programmed to sweep the nozzles across the photomask at the same height and substantially along the same path. In an embodiment, the atomizing nozzle 306 and rinse nozzle 312 are positioned approximately 20-50 mm above the surface of the photomask 302. In an embodiment, the above flow rates and atomizing nozzle 306 configuration and distance above the photomask 302 are desirable for removing particles greater than 80 nm while not inducing any damage to the fragile features below 80 nm on the top surface of the photomask.

At 708 a liquid having a controlled gas content 330 is flowed to the topside of the photomask 302 while simultaneously applying megasonic energy 320 from the backside of the photomask 302. In an embodiment, the rinse nozzle 312 is positioned over the top surface and slightly off-center of the photomask 302 to flow the liquid having a controlled gas content 330. In an embodiment, the liquid 330 comprises a component having a dissolved O2 gas concentration less than 30 ppb. In an embodiment the liquid 330 comprises a component having a dissolved H2, He, Ar, or N2 gas concentration of 0.3-18 ppm in order to achieve a low intensity cavitation on the top surface of the photomask 330. In an embodiment the liquid 330 comprises a component having a dissolved H2, He, Ar, or N2 gas concentration of 1-2.5 ppm. When DI water is the liquid component, H2 gas is effectively added because 2.5 ppm is the saturation level of H2 gas in degasified DI water. In an embodiment, liquid 330 comprises N2 gas dissolved at approximately 17 ppm, which is the saturation level of N2 gas in degasified DI. Alternatively, an inert gas may be dissolved below its saturation level with additional control and monitoring.

In an embodiment, a 200 mm photomask 302 is rotated at approximately 5-30 rpm while flowing the controlled gas content liquid 330 to the top surface of photomask 302. At rotational speeds significantly above 50 rpm the liquid 330 flows off the 200 mm photomask too quickly and does not effectively transmit megasonic energy. Additionally liquid 326 on the backside of the photomask 302 can be depleted when the rotational speed is too high. Between 5-30 rpm the liquid 330 coverage on the top surface of the 200 mm photomask is considered desirable.

In an embodiment, megasonic energy 320 is applied from the backside of the photomask 302 from a full coverage megasonic plate 328. As used herein full coverage means that the megasonic plate has a diameter or width greater than the diameter or width of the photomask. In an embodiment, megasonic energy 320 is applied at a power of 0.16-0.016 W/cm2, which is considered relatively low in conventional megasonic cleaning. In an embodiment, megasonic energy is applied at a frequency of 900 kHz-3 MHz. Although higher frequencies could also be utilized. In an embodiment, the liquid having a controlled gas content and low power at megasonic frequency is desirable for removing particles less than 80 nm while not inducing any damage to the fragile features below 80 nm on the top surface of the photomask.

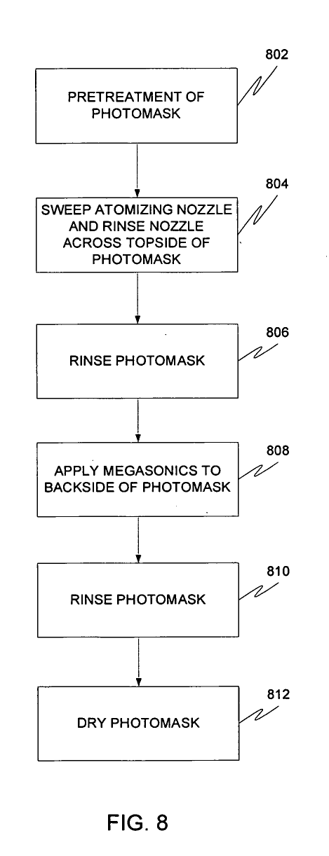

FIG. 8 is a flow diagram of a method for cleaning a photomask 302 in accordance with one embodiment where the atomized spray 308 and megasonic energy 320 are applied sequentially. At 802 the photomask is optionally pretreated to make the top surface of the photomask 302 hydrophilic and to remove any residual organics such as photoresist, which is hydrophobic. A hydrophilic photomask surface is beneficial because the cleaning solution spreads and wets the top surface of the photomask, which leads to more efficient cleaning. In an embodiment, the photomask is made hydrophilic by ashing the surface in a separate chamber with water vapor and an inert gas. Alternatively 02 gas and an inert gas can be used for ashing. In another embodiment, the photomask 302 is made hydrophilic by applying an ozonated DI water solution in the same chamber that the cleaning operations 804-812 are performed in. An ozonated DI water solution containing approximately 20-50 ppm O3 can be dispensed from the rinse nozzle 312, or alternatively a separate nozzle (not shown) at approximately 1 L/min for 30-60 seconds while rotating the photomask 302 at 100-200 rpm.

At 804 the atomizing nozzle 306 and rinse nozzle 312 are swept across the topside of the photomask 302 for 1-4 minutes at a sweep rate of approximately 2 complete sweeps per minute, though the time can be more or less depending upon the amount of contamination. The atomizing nozzle 306 and rinse nozzle 312 are positioned approximately 20-50 mm from the top surface of the photomask 302. The rinse nozzle 312 dispenses a rinsing solution 314 at approximately 1 L/min, while the atomizing nozzle 306 sprays cleaning solution 308 at approximately 50-70 mL/min and N2 at a flow rate of 70,000-140,000 sccm. The photomask 302 is rotated at approximately 75-100 rpm. The sweeping of atomizing nozzle 306 and rinse nozzle 312 is then stopped.

At 806 the photomask 302 is then rinsed. The rinse nozzle 312 dispenses a rinsing solution 314 for 10-30 seconds at 1-2 L/min, while rotating the photomask 302 at 75-100 rpm. In an embodiment, the rinse nozzle is stationary above the photomask. In an embodiment, the rinsing solution is DI water. In one embodiment, a small amount of AM-Clean chemistry is added to the rinsing solution to make it more conductive, thereby preventing electrostatic discharge (ESD) during the rinse operation. In another embodiment, the rinsing solution can be saturated with CO2 gas to make it more conductive.

At 808 megasonic energy 320 is applied from the backside of the photomask 302. Low power megasonic energy 320 is applied at approximately 0.16-0.016 W/cm2 from full coverage megasonic plate 328 at a frequency between 900 kHz-3 MHz. The photomask 302 is rotated at 5-30 rpm. A liquid with a controlled gas content 330 is simultaneously flowed to the top surface of the photomask 330. The liquid 330 may be degasified DI water, or the same as the cleaning solution used at 804. In an embodiment, the liquid 330 comprises a DI water component that is degasified to contain less than 30 ppb dissolved O2 gas. In an embodiment, the degasified DI water component contains less than 10 ppb dissolved O2 gas. In an embodiment, 0.3-18 ppm of an inert gas such as H2, He, Ar or N2 is redissolved into the degasified DI water in order to achieve controlled cavitation on the top surface of the photomask 302.

At 810 the photomask 302 is then rinsed. In an embodiment a rinsing solution comprising DI water saturated with CO2 gas is flowed to the top surface of the photomask 302 at 1-2 L/min, for 60-120 seconds, while rotating the photomask 302 at 100-200 rpm. At 820 the photomask 302 is spun dry at 1,000 rpm for 60 seconds.

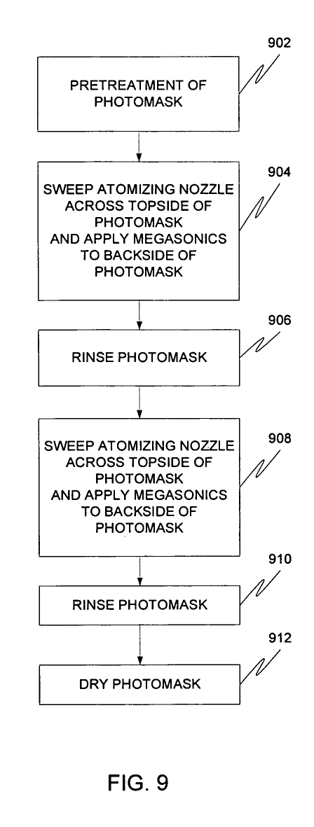

FIG. 9 is a flow diagram of a method for cleaning a photomask in accordance with one embodiment where the atomized spray 308 and megasonic energy 320 are applied simultaneously. At 902 the photomask is pretreated, for example, by ashing or flowing an ozonated DI water similarly as described at 802.

At 904 the atomizing nozzle 306 and rinse nozzle 312 are swept across the topside of the photomask 302 while megasonic energy 320 is simultaneously applied from the backside of the photomask 302. In an embodiment, the atomizing nozzle 206 and rinse nozzle 312 are swept across the topside of the photomask 302 for 1-4 minutes at a sweep rate of approximately 2 complete sweeps per minute. The atomizing nozzle 306 sprays cleaning solution 308 similarly as describe at 804. The rinse nozzle 312 dispenses a liquid having a controlled gas content at approximately 1 L/Min. Low megasonic energy 320 is applied at approximately 0.1-0.016 W/cm2 from a full coverage megasonic plate 328 at a frequency between 900 kHz-3 MHz. The photomask 302 is rotated at a rate of 20-50 rpm. The rotation is slower than at 804 where the atomizing spray 308 is applied alone, and faster than at 808 where the megasonic energy 320 is applied alone. The compromised rotation of 20-50 rpm balances the consideration for effectively rinsing away particles dislodged due to the atomized spray while at the same time allowing the solutions to remain on the top surface of the photomask for a sufficient amount of time to transfer megasonic energy. In an alternative embodiment, rinse nozzle 312 dispensing the liquid having a controlled gas content is not swept across the topside of the photomask along with the atomizing nozzle 306, and instead the rinse nozzle 312 remains stationary. In an embodiment, the rinse nozzle 312 is positioned slightly off-center the photomask 302.

At 906 the photomask 302 is rinsed similarly as at 806. At 908 the atomizing nozzle 306 is swept across the topside of the photomask 302 while megasonic energy 320 is simultaneously applied from the backside of the photomask 302 similarly as at 904. The photomask 302 is then rinsed and dried at 910 and 912 similarly as at 810 and 812.

In the foregoing specification, various embodiments of the invention have been described. It will, however, be evident that various modifications and changes may be made thereto without departing from the broader spirit and scope of the invention as set forth in the appended claims. The specification and drawings are, accordingly, to be regarded in an illustrative sense rather than a restrictive sense.

What is claimed is:

1. A method for cleaning a workpiece comprising:
supplying a gas and a cleaning solution to an atomizing nozzle;
atomizing the cleaning solution;
spraying the top surface of the workpiece with the atomized cleaning solution;
flowing a liquid comprising degasified DI water with a dissolved O2 gas concentration below 30 ppb to the top surface of the workpiece from a rinse nozzle; and
applying megasonic energy from the backside of the workpiece.

2. The method of claim 1 wherein the workpiece is a photomask having a pattern less than 80 nm.

3. The method of claim 1 wherein atomizing the cleaning solution comprises initially mixing the cleaning solution and the gas outside the atomizing nozzle.

4. The method of claim 1 wherein the atomizing nozzle is positioned 20-50 mm from the top surface of the workpiece.

5. The method of claim 1 wherein the degasified DI water further comprises 0.3-18 ppm of a dissolved inert gas.

6. The method of claim 1 wherein the megasonic energy is applied from the backside of the workpiece at a power in the range of 0.016-0.16 W/cm2.

7. The method of claim 1, further comprising stopping spraying the top surface of the workpiece with the atomized cleaning solution prior to applying megasonic energy from the backside of the workpiece.

8. The method of claim 1, wherein spraying the top surface of the workpiece with the atomized cleaning solution and applying megasonic energy from the backside of the workpiece occur simultaneously.

9. The method of claim 1 further comprising: treating a surface of the workpiece to make the surface hydrophilic prior to spraying the top surface of the workpiece with the atomized cleaning solution.

10. The method of claim 1 wherein spraying the top surface of the workpiece with the atomized cleaning solution and flowing liquid comprising degasified DI water to the top surface of the workpiece further comprises:
simultaneously sweeping the atomizing nozzle and rinse nozzle and across the workpiece.

11. A method for cleaning a workpiece comprising:
treating a topside of the workpiece to make the topside hydrophilic;
sweeping an atomizing nozzle and rinse nozzle across the topside of the workpiece, wherein the atomizing nozzle sprays the topside of the workpiece with an atomized cleaning solution and the rinse nozzle flows a rinsing solution to the topside of the workpiece; and
applying megasonic energy to a backside of the workpiece.

12. The method of claim 11 wherein the workpiece is a photomask.

13. The method of claim 11 further comprising:
stopping sweeping the atomizing nozzle and rinse nozzle across the topside of the workpiece prior to applying megasonic energy from the backside of the workpiece.

14. The method of claim 11 wherein sweeping the atomizing nozzle and rinse nozzle across the topside of the workpiece and applying megasonic energy to a backside of the workpiece are performed simultaneously.

15. The method of claim 11, wherein sweeping an atomizing nozzle and rinse nozzle across the topside of the workpiece comprises sweeping the atomizing nozzle and rinse nozzle substantially along the same path.

16. A cleaning apparatus comprising:
a chamber having a platter therein;
an atomizing nozzle disposed above the platter to spray droplets, the atomizing nozzle coupled to a cleaning solution source and a gas source, the atomizing nozzle configured to initially mix the cleaning solution and the gas outside the atomizing nozzle; and
a rinse nozzle disposed above the platter, the rinse nozzle connected with a liquid source having a dissolved O2 concentration of less than 30 ppb; and
a megasonic transducer plate connected with the platter.

17. The cleaning apparatus of claim 16, wherein the liquid source has a dissolved inert gas concentration of 0.3-18 ppm.

18. The cleaning apparatus of claim 16, wherein the atomizing nozzle and rinse nozzle are configured to sweep across the workpiece support.

19. The cleaning apparatus of claim 16, wherein the atomizing nozzle and rinse nozzle are configured to sweep across the workpiece support at the same height from the workpiece support.

20. The cleaning apparatus of claim 16, wherein the atomizing nozzle and rinse nozzle are configured to sweep across the workpiece support substantially along the same path.
